(19) United States
(12) Patent Application Publication
(10) Pub. No.: US 2026/0229975 A1
(43) Pub. Date: Aug. 6, 2026

(54) ELECTRIC MACHINE, METHOD FOR PRODUCING A MECHANICAL MAGNETIC-FIELD-ATTENUATING MECHANISM, MECHANICAL MAGNETIC-FIELD-ATTENUATING MECHANISM, AND KIT OF PARTS

(71) Applicant: Schaeffler Technologies AG & Co. KG, Herzogenaurach (DE)

(72) Inventors: László Sarkadi, Szombathely (HU); Shen Ding, Achern (DE); Martin Häßler, Graben-Neudorf (DE)

(73) Assignee: Schaeffler Technologies AG & Co. KG, Herzogenaurach (DE)

(21) Appl. No.: 19/151,996

(22) PCT Filed: Dec. 8, 2023
(86) PCT No.: PCT/DE2023/100951

§ 371 Date: Jul. 30, 2025

(30) Foreign Application Priority Data
Jan. 30, 2023 (DE) 10 2023 102 104.4

(51) Int. Cl. H02K 21/02; H02K 1/2753; H02K 16/02

(52) U.S. Cl. CPC H02K 21/029; H02K 1/2753; H02K 16/02

(57) ABSTRACT

An electric machine for use within a vehicle powertrain, including a stator and a rotor which is separated from the stator by an air gap. The rotor has a first rotor body with a first permanent magnet group and a second rotor body with a second permanent magnet group. The first and second rotor bodies are rotatable relative to each other about a common rotational axis against the effect of first rotational stiffness by a mechanical field-attenuating mechanism. At least one first spring leg of the first leg spring is held in a first receiving shoe, which is received in a first receiving pocket of the first rotor body and fixed to the first rotor body such that the first spring leg of the first leg spring is coupled to the first rotor body in a play-free manner in the axial and circumferential directions relative to the first rotor body.

### CROSS-REFERENCE TO RELATED APPLICATIONS

This application is a U.S. National Stage Application of Patent Cooperation Treaty (PCT) Application No. PCT/DE2023/100951 filed Dec. 8, 2023, which claims priority to German Patent Application 10 2023 102 104.4, filed Jan. 30, 2023. The content of these applications is incorporated by reference herein in their entireties.

### FIELD OF INVENTION

The present invention relates to an electric machine, in particular for use within a powertrain of a hybrid or fully electrically driven motor vehicle, including a stator and a rotor separated from the stator by an air gap, wherein the rotor has at least a first rotor body with a first group of permanent magnets and a second rotor body with a second group of permanent magnets, wherein the first rotor body and the second rotor body can be rotated relative to each other about a common rotational axis against the effect of a first torsional stiffness by means of a mechanical field-attenuating mechanism. The invention further relates to a method for producing a mechanical field-attenuating mechanism, a mechanical field-attenuating mechanism, and a kit-of-parts.

### BACKGROUND

Electric motors are increasingly being used to drive motor vehicles to create alternatives to internal combustion engines that require fossil fuels. Significant efforts have already been made to improve the suitability of electric drives for everyday use and also to be able to offer users the driving comfort to which they are accustomed.

A detailed description of an electric drive can be found in an article in the German automotive magazine ATZ, volume 113, May 2011, pages 360-365 by Erik Schneider, Frank Fickl, Bernd Cebulski and Jens Liebold with the title: “Hochintegrativ und flexibel—Elektrische Antriebseinheit für E-Fahrzeuge” [Highly Integrative and Flexible—Electric Drive Unit for Electric Vehicles], which is probably the closest prior art. This article describes a drive unit for an axle of a vehicle, which includes an electric motor arranged to be coaxial to a bevel gear differential. Such drive units are also referred to as e-axles or electrically operable powertrains.

Electric machines are subject to losses during operation due to magnetic reversal, which are grouped together as iron losses and reduce the machine efficiency. In mobile applications, low efficiency of the electric machine means a reduced range of the vehicle or increased demand for battery capacity. It is therefore an ongoing goal, especially in mobile applications with purely electric drive, to minimize the iron losses described.

An example of such an electric machine with iron losses, as it can be used within the powertrain of a hybrid or fully electrically driven motor vehicle, is the permanently excited synchronous machine. Due to its high power density compared to other types of machines, it is preferred for use in the field of electromobility, where the available installation space is often a limiting factor. The excitation field of the machine is usually generated by permanent magnets that are arranged in the rotor of the machine. In a permanently excited synchronous machine, it is possible to dispense with a slipring contact which is necessary in electrically excited synchronous machines to supply power to an excitation coil arranged on the rotor.

However, a disadvantage of permanent excitation is that the excitation field cannot be easily modified. In principle, a synchronous machine can be operated beyond its rated speed by controlling the field-attenuating range. In this range, the machine is operated at its maximum rated power, with the torque delivered by the machine decreasing as the speed increases. Electrically excited synchronous machines can be operated very easily in the field-attenuating range by reducing the excitation current. Even in the case of permanent magnet machines, there are known ways of generating an air gap field component by means of a suitable current supply to the stator of the machine, which counteracts the excitation field generated by the permanent magnets and thus weakens it. However, such control of the machine causes increased losses, so that the machine can only be operated with a reduced efficiency in this range.

An effective method for reducing iron losses in electric machines is to deliberately weaken the magnetic field between stator and rotor for operating points with high speeds, since the losses due to high-frequency magnetic reversal are lower with a weaker magnetic field. In addition to electrical, there are also mechanical approaches for targeted field attenuation. From the patent specifications US58211710, FR2831345, EP1085644, EP11867030, DE1012011708670, DE1012016103470, CN104600929 and CN105449969, a rotor of a radial flux machine is known which is divided in a manner perpendicular to the rotational axis into several rotor disks equipped with permanent magnets and which can be rotated relative to each other. Depending on the relative rotation between the rotor disks, the rotor provides the full magnetic field in a position with the magnetic poles aligned in the axial direction and a weakened magnetic field in a position rotated relative to this. Active or passive mechanisms are described which claim to be able to switch between these two positions depending on the rotor speed or torque and thus enable more efficient operation of the electric machine over the entire engine characteristic map.

DE 10 12021 101 898 describes an arrangement in which the rotor of a radial flux machine is divided into two partial rotors, the individual rotor disks of which alternate in the axial direction. One part of the rotor is directly connected to the rotor shaft, the other part is connected to the rotor shaft in a torque-transmitting manner via a torsional stiffness. The torsional stiffness is selected in such a way that at low torque the partial rotors are in a torsional position with a weakened magnetic field and at high torque the partial rotors are in a torsional position with a full magnetic field. DE 10 12021 101 904 claims a structurally designed mechanical module that can be introduced into the interior of the permanent magnet-equipped rotor disks, creates the described connections of the partial rotors to the rotor shaft, and allows an adjustment characteristic curve to be defined via the torsional stiffness, which is implemented with springs and roller-equipped cam drives.

All previously mentioned passive solutions, which use a torque as a sensor variable to trigger a relative rotation between two partial rotors against a torsional stiffness, assume that the total electromagnetic torque generated by the stator current supply in the case of the initially field-attenuated position with non-aligned magnetic poles is simply distributed between the two partial rotors, approximately according to their share of the total length and according to their respective phase position to the stator field, regardless of the presence of the other partial rotor. Only then could a partial torque proportional to the total torque be easily directed against a torsional stiffness between the partial rotors or one of the partial rotors and the rotor shaft and bring about the desired rotation with increasing torque into the position with full magnetic field with aligned magnetic poles. However, tests and modeling by the applicant have shown that the actual situation is far more complicated.

Even in the de-energized case, there are interactions between the rotor disks of the two sub-rotors in the form of magnetic repulsion torques. The position with full magnetic field and aligned magnetic poles represents a labile equilibrium with vanishing repulsion torque. As the rotation begins from this equilibrium position, a repulsion torque arises which increases with increasing rotation until it reaches a maximum and then decreases again with further rotation. The course of the repulsion torque over the angle of rotation within an electrical period, the height of the maximum, and the angle of rotation at which it occurs depend strongly on the chosen type of arrangement of the permanent magnets within the rotor disks. The course over an electrical period is fundamentally non-linear.

In the case of the desired efficient stator current supply for different speeds, these magnetic repulsion torques increase in different ways, sometimes several times, depending on the speed. Overall, partial torques result which are in no case suitable to be easily directed against a torsional stiffness between the partial rotors or one of the partial rotors and the rotor shaft to cause a rotation of the partial rotors into the position with full magnetic field, since they do not point in the right direction for this due to the high proportion of magnetic repulsion torques.

For reliable adjustment behavior, it is necessary, among other things, that the adjustment characteristic curve of the mechanical field attenuation over the engine characteristic map neither changes undesirably nor exhibits excessive hysteresis. At the speeds of today's traction machines in the automotive sector, however, the effect of centrifugal force, in particular on existing torsional stiffnesses, which can be designed as compression springs, for example, results in an undesirably high shift of the adjustment characteristic curve towards higher torques. Increasing friction on guide elements of the torsional stiffness can also lead to excessive hysteresis in the adjustment characteristic curve.

### SUMMARY

In order to provide a functional arrangement in the sense of the aforementioned passive solutions for torque-adaptive field attenuation of the rotor of an electric machine, it is the object of the present disclosure to provide an electric machine which has improved mechanical field attenuation. The object is also to realize an optimized method for producing a field-attenuating mechanism and an improved mechanical field-attenuating mechanism. It is also the object of the present disclosure to provide a kit-of-parts for producing a mechanical field-attenuating mechanism for a rotor of an electric machine.

This object is addressed by an electric machine, in particular for use within a powertrain of a hybrid or fully electrically driven motor vehicle, including a stator and a rotor separated from the stator by an air gap, wherein the rotor has at least a first rotor body with a first group of permanent magnets and a second rotor body with a second group of permanent magnets, wherein the first rotor body and the second rotor body can be rotated relative to each other about a common rotational axis against the effect of a first torsional stiffness by means of a mechanical field-attenuating mechanism, wherein the first torsional stiffness is designed as a first leg spring arrangement having a first leg spring, which is arranged coaxially to the rotational axis and between the first rotor body and the second rotor body or between one of the rotor bodies and a rotor shaft in such a way that the rotation of one of the rotor bodies, which begins when the field-attenuating mechanism is adjusted, causes the first leg spring to open or close, wherein at least one first spring leg of the first leg spring is held in a first receiving shoe, which in turn is received in a first receiving pocket of the first rotor body and is fixed to the first rotor body in such a way that the first spring leg of the first leg spring is coupled to the first rotor body in a play-free manner in the axial as well as in the circumferential directions relative to the first rotor body.

This provides the advantage that an electric machine can be realized with a purely mechanical field-attenuating device, which reliably and cost-effectively adjusts the positions of permanent magnets within the rotor required for field attenuation as required, depending on the operating conditions of torque and speed. In principle, the present disclosure thus also avoids the need for actuators to intervene on or in the rotor from the outside.

Designing a torsional stiffness as a leg spring arrangement for defining an adjustment characteristic curve for attenuating the magnetic field by a relative rotation of the rotor bodies allows in particular the reduction of the centrifugal force influence on the adjustment characteristic curve and its hysteresis.

The play-free arrangement of a spring leg in a receiving shoe allows the spring leg to be positioned very precisely in the corresponding receiving pocket, which also contributes to a play-free arrangement of the spring leg in relation to the rotor body and to a corresponding tolerance compensation between the joined components.

This connection also makes it possible to adjust the center of gravity of the leg spring precisely to the rotational axis of the rotor, which is particularly important for high rotor speeds above 15,000 rpm with regard to imbalances.

A receiving shoe may be configured in such a way that it can transmit both a torque and forces that can stem from the reaction forces of the leg springs, for example.

It is also possible that the points of contact between a spring leg and a spring shoe, and possibly a wall of a receiving pocket, are at different radii, which means that forces can be introduced into the leg spring without lateral forces. Among other things, this can contribute to a particularly firm and secure clamping of a spring leg.

The electric machine can in particular be designed as a rotary machine. In the case of electric machines designed as rotary machines, a distinction is drawn in particular between radial flux machines and axial flux machines. A radial flux machine is characterized in that the magnetic field lines extend in the radial direction in the air gap formed between rotor and stator, while in the case of an axial flux machine the magnetic field lines extend in the axial direction in the air gap formed between rotor and stator. In the context of this present disclosure, it is possible that the electric machine is configured as a radial flux machine or axial flux machine.

A rotor is the rotating (spinning) part of an electric machine. The rotor particularly includes a rotor shaft and one or more rotor bodies formed of rotor lamination stacks which are arranged on the rotor shaft in a non-rotatable manner. The rotor shaft can be hollow, which on the one hand results in weight savings and on the other hand allows the supply of lubricant or coolant to the rotor body.

A rotor body for the purposes of the present disclosure is understood to mean the rotor without a rotor shaft. The rotor body is therefore made in particular of a rotor lamination stack and the permanent magnets inserted into the pockets of the rotor lamination stack or fixed to the circumference of the rotor lamination stack, as well as any axial cover parts for closing the pockets.

The permanent magnets can be inserted into the pockets of the rotor lamination stack. A single larger rotor magnet designed as a bar magnet or a plurality of smaller permanent magnetic elements can be provided for each pocket.

The rotor has a plurality of rotor bodies. Particularly, the rotor bodies are formed substantially of the same parts, in particular substantially identically. It is highly possible that the rotor bodies are formed from identical, in particular substantially identical rotor laminations. The rotor bodies are therefore particularly formed from a rotor lamination stack, which is composed of a plurality of laminated individual sheets or rotor laminations, usually made of electrical steel, which are layered and stacked one above the other to form a stack, i.e., the rotor lamination stack. The individual laminations can be held together in the rotor lamination stack by gluing, welding, or screwing. A rotor lamination stack can in particular also have permanent magnets that are inserted into the pockets of the rotor lamination stack, or that are fixed circumferentially to the rotor lamination stack.

Mechanical field-attenuating mechanisms are fundamentally known from the prior art. Particular mechanical field-attenuating mechanisms in connection with the present disclosure are described in patent publications DE102022106944A1, DE102022106945A1 (having corresponding U.S. pat. publ. US20250202327A1), DE102021101904B3, DE102021101898A1 and DE102021101900A1, and are hereby incorporated by reference into the disclosure of the present application.

According to an advantageous embodiment of the present disclosure, it can be provided that the first leg spring arrangement has a second leg spring, which is arranged coaxially to the rotational axis of the rotor and between the first rotor body and the second rotor body or between one of the rotor bodies and the rotor shaft in such a way that the rotation of one of the rotor bodies, which begins when the field-attenuating mechanism is adjusted, causes the second leg spring to open or close. The advantage of this design is that a second leg spring makes it possible to model and precisely adjust the adjustment characteristic curve. The leg springs can be of substantially identical or different design, depending on which application-specific requirements need to be implemented by the desired adjustment characteristic curve. The leg springs can be connected in series or parallel to each other.

According to a further development of the present disclosure, it may also be provided that the first leg spring has a first spring leg extending radially into the first rotor body and/or a second spring leg extending radially into the second rotor body,
and/or the first leg spring has a first spring leg extending axially into the first rotor body and/or a second spring leg extending axially into the second rotor body, and/or
the second leg spring has a first spring leg extending radially into the first rotor body and/or a second spring leg extending radially into the second rotor body,
and/or the second leg spring has a first spring leg extending axially into the first rotor body and/or a second spring leg extending axially into the second rotor body. This makes it possible to achieve a particularly compact radial or axial torsional stiffness depending on the given installation space situation.

Furthermore, according to an equally advantageous embodiment of the present disclosure, it may be provided that the first leg spring and the second leg spring are designed as substantially identical parts and are arranged rotated relative to each other by approximately 180° about the rotational axis, so that the first spring leg and the second spring leg of the first leg spring point in a common radial and/or axial direction and the first spring leg and the second spring leg of the second leg spring are oriented in a radial and/or axial direction opposite thereto. The advantageous effect of this design is that lateral forces occurring when the leg springs are actuated and a design imbalance in the rotating rotor can be avoided or at least reduced. For example, a pack of two identical opening and closing leg springs can be formed, in which the first and second leg springs are screwed into each other, made possible by a corresponding distance between the coils, and then arranged rotated 180° to each other. The leg springs may have a distance between the coils that is slightly greater than the wire thickness of the leg springs in the axial direction.

In an embodiment of the present disclosure, it can also be provided that at least one, such as all, of the leg springs are wound from a spring wire with a substantially rectangular cross-section. This makes it possible to increase the energy content of the leg springs in their installation space and to facilitate the bending torque-transmitting and lateral force-free suspension of the spring ends, which are designed as legs, in recesses of disks that form a structural unit with the partial rotors or the rotor shaft for transmitting torque.

It may also be advantageous to further develop the present disclosure in such a way that at least one, such as all, leg springs are preloaded. The advantage of this is that a torque at which the adjustment process should start can be defined. For this purpose, the leg springs in the arrangement can then be installed pretensioned about a certain angle of rotation, for example.

According to an advantageous embodiment of the present disclosure, it can be provided that the first receiving shoe can be inserted into the first receiving pocket with play.

The advantage of this design is that the position of the first spring leg of the first leg spring can be changed slightly and thus adjusted without impairing the coupling between the first spring leg and the first rotor body.

According to a further development of the present disclosure, it may also be provided that the first receiving shoe has a first receiving groove in which the first spring leg of the first leg spring is arranged in a play-free manner. This allows the adjustment characteristic curve of the leg spring arrangement to be set precisely. Another advantage is that it reduces the friction between the components and thus increases the service life of the leg spring arrangement.

Furthermore, according to an equally advantageous embodiment of the present disclosure, it may be provided that the first spring leg of the first leg spring projects from the first receiving groove, wherein the section projecting from the first receiving groove rests against a wall of the first receiving pocket. The advantageous effect of this design is that some of the mechanical loads during operation of the rotor can be absorbed by the corresponding rotor body.

According to a further particular embodiment of the present disclosure, it may be provided that the wall of the first receiving pocket has a convex contour projecting into the first receiving pocket. This has the particular effect that the positioning of the spring leg can be extensively adjusted relative to the receiving pocket.

Furthermore, the present disclosure can also be further developed in that the first receiving shoe has a first opening which is penetrated by a first fastening means, by means of which the first receiving shoe is fixed to the first rotor body. The advantage of this design is that it makes it particularly easy to adjust the clearance between the receiving shoe and the receiving pocket.

In an embodiment of the present disclosure, it can also be provided that the first leg spring arrangement has a second leg spring, which is arranged coaxially to the rotational axis of the rotor and between the first rotor body and the second rotor body or between one of the rotor bodies and the rotor shaft, in that the rotation of one of the rotor bodies, which begins when the field-attenuating mechanism is adjusted, causes the second leg spring to open or close, and the first leg spring and the second leg spring are designed as substantially identical parts and are arranged rotated relative to each other by approximately 180° about the rotational axis, so that the first spring leg and a second spring leg of the first leg spring point in a common radial and/or axial direction and a first spring leg and a second spring leg of the second leg spring are oriented in a radial and/or axial direction opposite thereto.

It may also be advantageous to further develop the present disclosure in such a way that the second spring leg of the first leg spring is held in a second receiving shoe, which in turn is received in a second receiving pocket of the second rotor body and fixed to the first rotor body in such a way that the second spring leg of the first leg spring is coupled to the second rotor body in a play-free manner in the axial direction as well as in the circumferential direction relative to the second rotor body and/or the first spring leg of the second leg spring is held in a third receiving shoe, which in turn is received in a third receiving pocket of the first rotor body and is fixed to the first rotor body in such a way that the first spring leg of the second leg spring is coupled to the first rotor body in a play-free manner in the axial direction as well as in the circumferential direction relative to the first rotor body and/or the second spring leg of the second leg spring is held in a fourth receiving shoe, which in turn is received in a fourth receiving pocket of the second rotor body and is fixed to the second rotor body in such a way that the second spring leg of the second leg spring is coupled to the second rotor body in a play-free manner in the axial direction as well as in the circumferential direction relative to the second rotor body. The advantage of this is that the adjustability of the adjustment characteristic curve can be improved accordingly.

According to a further embodiment of the object of the present disclosure, it can be provided that the first receiving shoe, the second receiving shoe, the third receiving shoe and the fourth receiving shoe are designed identically. This makes it possible to reduce the production costs for the receiving shoes due to the increased degree of uniformity.

The object of the present disclosure is also addressed by a method for producing a mechanical field-attenuating mechanism, including the following steps:
providing a first rotor body, having a first receiving pocket, and a second rotor body,
providing a first torsional stiffness, which is designed as a first leg spring arrangement having a first leg spring, which has a first spring leg and a second spring leg,
providing a first receiving shoe,
fixing the first receiving shoe to the first spring leg in a play-free manner,
inserting the first receiving shoe into the first receiving pocket with play, and
fixing the receiving shoe to the first rotor body, so that the first spring leg of the first leg spring is coupled to the first rotor body in a play-free manner in the axial direction as well as in the circumferential direction relative to the first rotor body,
coupling the second spring leg to the second rotor body or a rotor shaft,
so that the first rotor body and the second rotor body can be rotated relative to each other about a common rotational axis against the effect of the first torsional stiffness, so that the rotation of one of the rotor bodies, which begins when the field-attenuating mechanism is adjusted, can cause the first leg spring to open or close.

The object of the present disclosure can also be achieved by a mechanical field-attenuating mechanism for a rotor of an electric machine, in particular for use within the powertrain of a hybrid or fully electrically driven motor vehicle, wherein the rotor has at least one first rotor body and a second rotor body, wherein the first rotor body and the second rotor body can be rotated relative to each other about a common rotational axis against the effect of a first torsional stiffness, wherein the first torsional stiffness is designed as a first leg spring arrangement having a first leg spring, which is arranged coaxially to the rotational axis and between the first rotor body and the second rotor body or between one of the rotor bodies and a rotor shaft in such a way that the rotation of one of the rotor bodies, which begins when the field-attenuating mechanism is adjusted, causes the first leg spring to open or close, wherein at least one first spring leg of the first leg spring is held in a first receiving shoe, which in turn is received in a first receiving pocket of the first rotor body and is fixed to the first rotor body in such a way that the first spring leg of the first leg spring is coupled to the first rotor body in a play-free manner in the axial as well as in the circumferential directions relative to the first rotor body.

Furthermore, the object of the present disclosure can also be addressed by a kit-of-parts for producing a mechanical field-attenuating mechanism for a rotor of an electric machine, in particular for use within the powertrain of a hybrid or fully electrically driven motor vehicle, including
a first rotor body having a first receiving pocket, and a second rotor body, wherein the first rotor body and the second rotor body can be rotated relative to each other about a common rotational axis against the effect of a first torsional stiffness, a first torsional stiffness, which is designed as a first leg spring arrangement having a first leg spring, which can be positioned coaxially to the rotational axis and between the first rotor body and the second rotor body or between one of the rotor bodies and a rotor shaft in such a way that the rotation of one of the rotor bodies, which begins when the field-attenuating mechanism is adjusted, can cause the first leg spring to open or close, and the first leg spring has at least one first spring leg, and
a first receiving shoe, in which the first spring leg can be positioned and the receiving shoe in turn can be received in the first receiving pocket of the first rotor body and can be fixed to the first rotor body in such a way that the first spring leg of the first leg spring can be coupled to the first rotor body in a play-free manner in the axial as well as in the circumferential direction relative to the first rotor body.

One advantage of the kit-of-parts is that it offers a simple and flexible solution for the production and assembly of a mechanical field-attenuating mechanism. By using preconfigured and preassembled parts, installation and maintenance can be carried out more quickly and easily. The kit-of-parts is also more flexible and adaptable for different applications and vehicle types. It can also reduce costs by simplifying the supply chain and reducing stock levels. The kit-of-parts can, for example, be a packaging unit. Furthermore, it is possible to design the kit-of-parts as a compilation of separate storage containers for storing the individual components or the respective component groups of the kit-of-parts.

### BRIEF DESCRIPTION OF THE DRAWINGS

The present disclosure is explained in more detail below with reference to figures without limiting the general concept of the present disclosure.

In the figures:

FIG. 1 shows an electric machine in a sectional view,

FIG. 2 shows a schematic block diagram of a rotor with a mechanical field-attenuating mechanism,

FIG. 3 shows a first embodiment of a leg spring arrangement with two rotor bodies in an exploded perspective view,

FIG. 4 shows a perspective view of a first embodiment of a leg spring arrangement with two rotor bodies in an assembled state,

FIG. 5 shows a perspective view of a rotor body with a first embodiment of a leg spring arrangement fixed thereto,

FIG. 6 shows a cross-sectional view of a rotor body with a first embodiment of a leg spring arrangement fixed thereto,

FIG. 7 shows a detailed sectioned enlargement of a rotor body with a first embodiment of a leg spring arrangement fixed thereto,

FIG. 8 shows an axial sectional view of a rotor body with a first embodiment of a leg spring arrangement fixed thereto,

FIG. 9 shows a perspective view of a first embodiment of a leg spring arrangement,

FIG. 10 shows three embodiments of a receiving shoe for a spring leg, each in a perspective view,

FIG. 11 shows a perspective view of a fourth embodiment of a receiving shoe with a leg spring arrangement,

FIG. 12 shows a perspective view of a rotor body with a leg spring arrangement fixed thereto,

FIG. 13 shows a perspective view of a rotor body with a further embodiment of a leg spring arrangement fixed thereto,

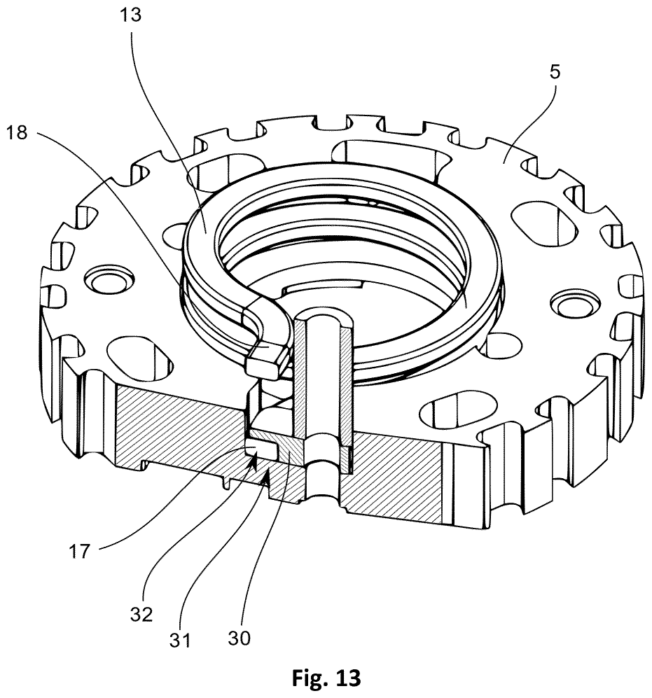

FIG. 14 shows a kit-of-parts for producing a mechanical field-attenuating mechanism for a rotor of an electric machine,

FIG. 15 shows a rotor in a cross-sectional view,

FIG. 16 shows a detailed view of the rotor in a cross-sectional view.

### DETAILED DESCRIPTION

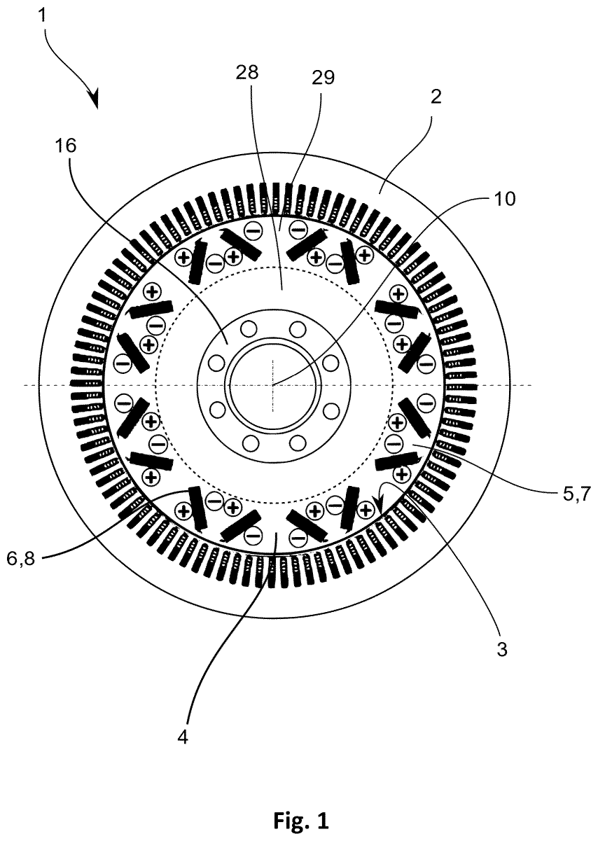

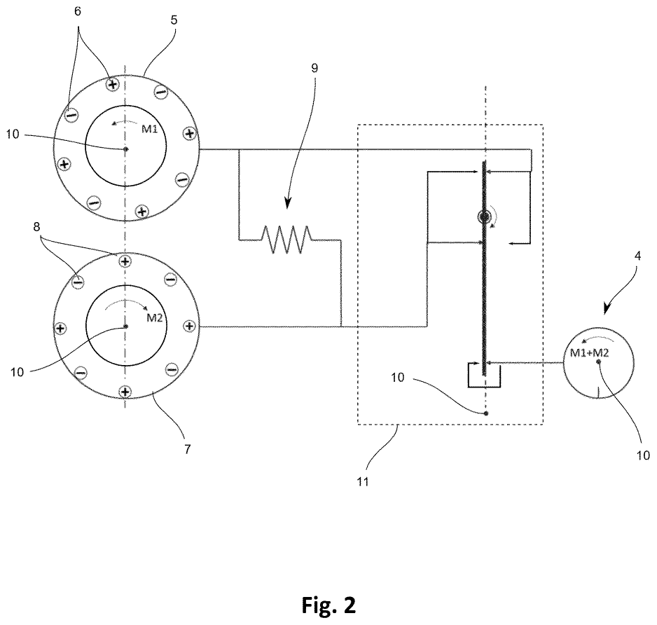

FIG. 1 shows an electric machine 1, in particular for use within the powertrain of a hybrid or fully electrically driven motor vehicle. The electric machine 1 is configured as a radial flux machine and includes a stator 2 and a rotor 4 which is separated from the stator 2 by an air gap 3, wherein the rotor 4 has at least one first rotor body 5 with a first group of permanent magnets 6 and a second rotor body 7 with a second group of permanent magnets 8, which can be easily understood by looking at FIG. 1 together with FIG. 2.

The first rotor body 5 and the second rotor body 7 can be rotated relative to each other about a common rotational axis 10 against the effect of a first torsional stiffness 9 by means of a mechanical field-attenuating mechanism 11. The two rotor bodies 5, 7 are substantially formed from identical rotor laminations, wherein the position and the number of the permanent magnets 6 of the first group and the number of permanent magnets 8 of the second group in the rotor bodies 5, 7 are identical.

The field-attenuating mechanism 11, shown by way of example in FIG. 2 includes a lever element, which is not designated in further detail, which can be pivoted about a pivot point, wherein the first rotor body 5 can be coupled to a first lever section and the second rotor body 7 can be coupled to a second lever section of the lever element. The first lever section and the second lever section are arranged on opposite sides of the lever, so that the first rotor body 5 and the second rotor body 7 can be rotated relative to each other by tilting the lever element for a desired adjustment of the mechanical field-attenuating mechanism 11. This field-attenuating mechanism 11 is described in detail in DE102022106944 and DE102022106945, so that reference is made here to these documents in order to avoid repetition.

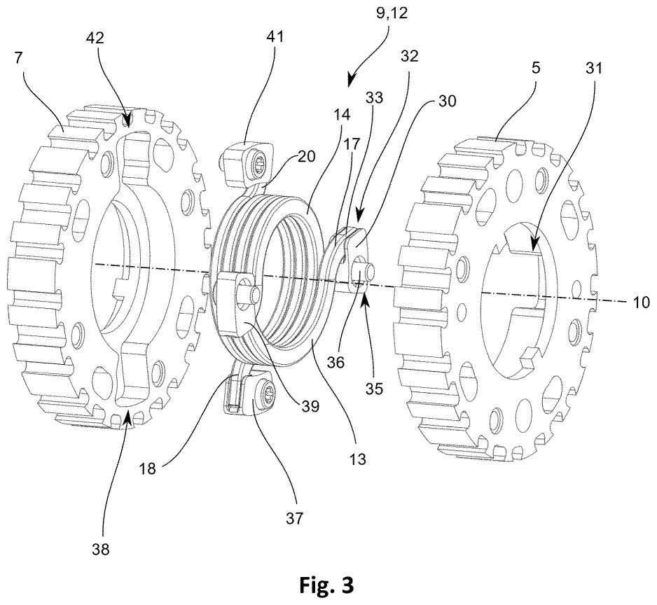

As can be seen from FIG. 3, the first torsional stiffness 9 is designed as a first leg spring arrangement 12 having a first leg spring 13, which is arranged coaxially to the rotational axis 10 and between the first rotor body 5 and the second rotor body 7 in such a way that the rotation of one of the rotor bodies 5, 7, which begins when the field-attenuating mechanism 11 is adjusted, causes the first leg spring 13 to open or close. Even if it is not shown in the figures, it is nevertheless possible that the first leg spring 13 is also arranged between one of the rotor bodies 5, 7 and the rotor shaft 16 in a torque-transmitting manner.

The first leg spring arrangement 12 has a second leg spring 14, which is arranged coaxially to the rotational axis 10 of the rotor 4 and between the first rotor body 5 and the second rotor body 7 in such a way that the rotation of one of the rotor bodies 5, 7, which begins when the field-attenuating mechanism 11 is adjusted, causes the second leg spring 14 to open or close. As shown in FIG. 3, the first leg spring 13 and the second leg spring 14 are designed substantially identically and are arranged rotated relative to each other by approximately 180° about the rotational axis 10, so that the first spring leg 17 and the second spring leg 18 of the first leg spring 13 point radially outwards offset by 90° in the circumferential direction, and the first spring leg 19 and the second spring leg 20 of the second leg spring 14 are also oriented radially outwards offset by 90° in the circumferential direction.

The first leg spring 13 has a first spring leg 17 extending radially into the first rotor body 5 and a second spring leg 18 extending radially into the second rotor body 7. Similarly, the second leg spring 14 also has a first spring leg 19 extending radially into the first rotor body 5 and a second spring leg 20 extending radially into the second rotor body 7.

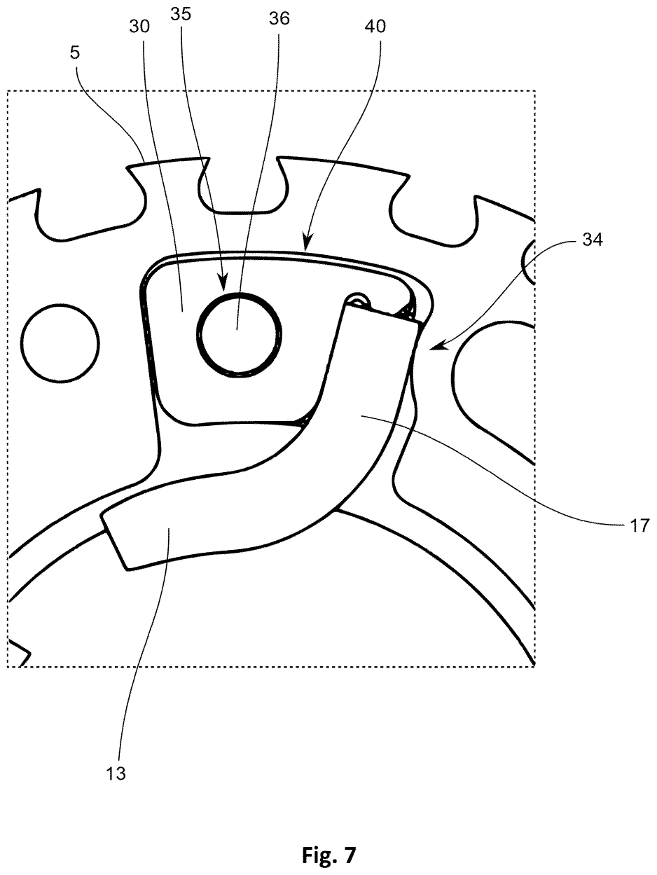

The first spring leg 17 of the first leg spring 13 is held in a first receiving shoe 30, which in turn is received in a first receiving pocket 31 of the first rotor body 5 and is fixed to the first rotor body 5 in such a way that the first spring leg 17 of the first leg spring 13 is coupled to the first rotor body 5 in a play-free manner in the axial direction as well as in the circumferential direction relative to the first rotor body. The first receiving shoe 30 can be inserted into the first receiving pocket 31 with play, which can also be clearly seen in FIG. 7, where the gap between the receiving shoe 41 and the receiving pocket 42 is clearly visible.

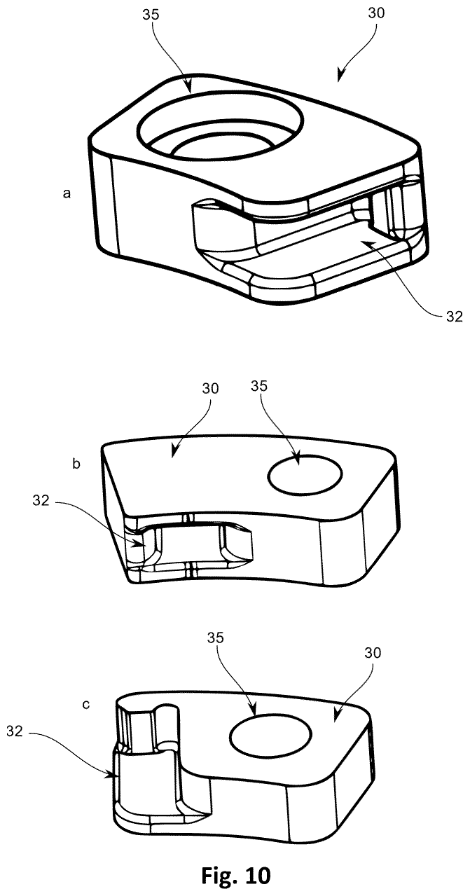

FIG. 3 also shows that the first receiving shoe 30 has a first receiving groove 32 in which the first spring leg 17 of the first leg spring 13 is arranged in a play-free manner, for example by means of a press fit. FIG. 10 shows various embodiments of this receiving groove 32.

The first spring leg 17 of the first leg spring 13 projects from the first receiving groove 32, wherein the section 33 projecting from the first receiving groove 32 rests against a wall 34 of the first receiving pocket 31. This allows part of the shoe load to be absorbed by the rotor body 5. The wall 34 of the first receiving pocket 31 has a convex contour projecting into the first receiving pocket 31, which can also be clearly seen from the detailed representation of FIG. 7. This ensures, for example, that the position of the spring leg 17 can also be adjusted in the direction of rotation.

FIG. 3 also shows that the first receiving shoe 30 has a first opening 35 which is penetrated by a first fastening means 36, by means of which the first receiving shoe 30 is fixed to the first rotor body 5.

FIG. 3 also shows that the second spring leg 18 of the first leg spring 13 is held in a second receiving shoe 37, which in turn is received in a second receiving pocket 38 of the second rotor body 7 and is fixed to the first rotor body 7 in such a way that the second spring leg 18 of the first leg spring 13 is coupled to the second rotor body 7 in a play-free manner in the axial direction as well as in the circumferential direction relative to the second rotor body.

In an analogous manner, the first spring leg 19 of the second leg spring 14 is also held in a third receiving shoe 39, which in turn is received in a third receiving pocket 40 of the first rotor body 5 and is fixed to the first rotor body 5 in such a way that the first spring leg 19 of the second leg spring 14 is coupled to the first rotor body 5 in a play-free manner in the axial direction as well as in the circumferential direction relative to the first rotor body.

Finally, the second spring leg 20 of the second leg spring 14 is also held in a fourth receiving shoe 41, which in turn is received in a fourth receiving pocket 42 of the second rotor body 7 and is fixed to the second rotor body 7 in such a way that the second spring leg 20 of the second leg spring 14 is coupled to the second rotor body 7 in a play-free manner in the axial direction as well as in the circumferential direction relative to the second rotor body.

FIG. 3 also shows that the first receiving shoe 30, the second receiving shoe 37, the third receiving shoe 39 and the fourth receiving shoe 41 are designed identically.

Adjustable and fixable elements are thus arranged between the spring legs 17, 18, 19, 20 and the rotor bodies 5, in their position within a receiving pocket 31, 38, 40, 42, by means of the receiving shoes 30, 37, 39, 41. The receiving shoes 30, 37, 39, 41 are pressed onto the spring legs 17, 18, 19, 20, for example via a corresponding oversize, so that they are fixed to each other in a play-free manner. The spring legs 17, 18, 19, 20 with the pre-assembled receiving shoes 30, 37, 39, 41 can be positioned in the rotor bodies 5, 7 using an assembly tool (not shown). Since a gap is formed between the receiving pockets 31, 38, 42 and the receiving shoes 30, 37, 39, 41, i.e., the receiving shoes 30, 37, 39, 41 engage in the receiving pockets 31, 38, 42 with play, the position of the receiving shoes 30, 37, 39, 41 in the receiving pockets 31, 38, 42 can be adjusted. The receiving shoes 30, 37, 39, 41 then positioned in the receiving pockets 31, 38, 42 can subsequently be fixed in place by the fastening means 36. These are shown in the figures as screws. However, they can also be designed as rivets or the fastening means 36 can be provided in the form of a soldered or welded joint.

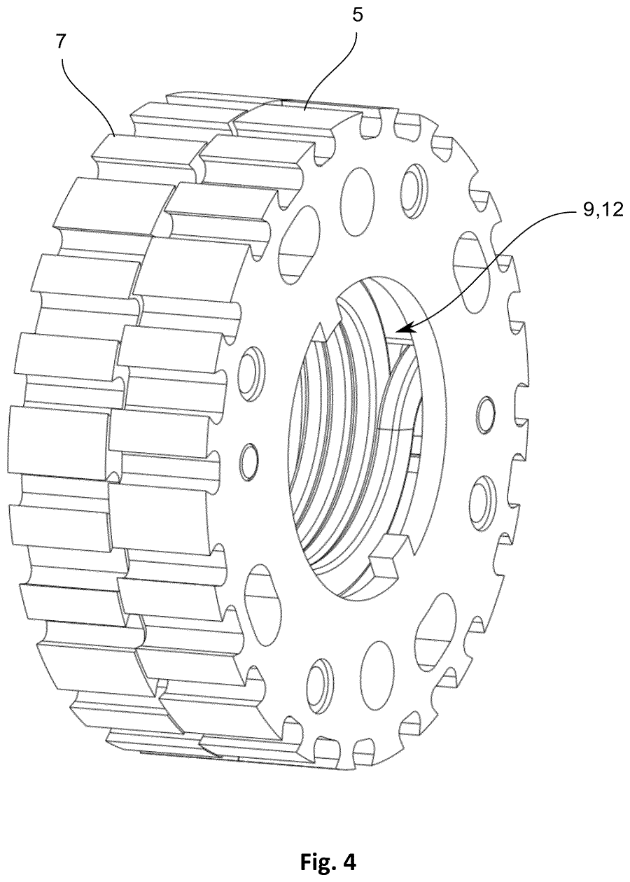

FIG. 4 shows the arrangement known from FIG. 3 in an assembled state. The mechanical field-attenuating mechanism 11 can be produced or assembled as follows, for example. First, a first rotor body 5 having a first receiving pocket 31 and a second rotor body 7 are provided, as well as a first torsional stiffness 9, which is designed as a first leg spring arrangement 12 having a first leg spring 13, which has a first spring leg 17 and a second spring leg 18. Furthermore, a first receiving shoe 30 is also provided.

The first receiving shoe 30 is then fixed to the first spring leg 17 in a play-free manner, for example by means of a press fit. The first receiving shoe 30 with the first spring leg 17 fixed therein is then inserted into the first receiving pocket 31 with play. In this assembly position, the receiving shoe 30 is then fixed to the first rotor body 5 so that the first spring leg 17 of the first leg spring 13 is coupled to the first rotor body 5 in a play-free manner in the axial direction as well as in the circumferential direction relative to the first rotor body. To complete the assembly of the first torsional stiffness 9, the second spring leg 18 is then coupled to the second rotor body 7 or a rotor shaft 16.

As a result, the first rotor body 5 and the second rotor body 7 can then be rotated relative to each other about a common rotational axis 10 against the effect of the first torsional stiffness 9, so that the rotation of one of the rotor bodies 5, 7, which begins when the field-attenuating mechanism 11 is adjusted, can cause the first leg spring 13 to open or close.

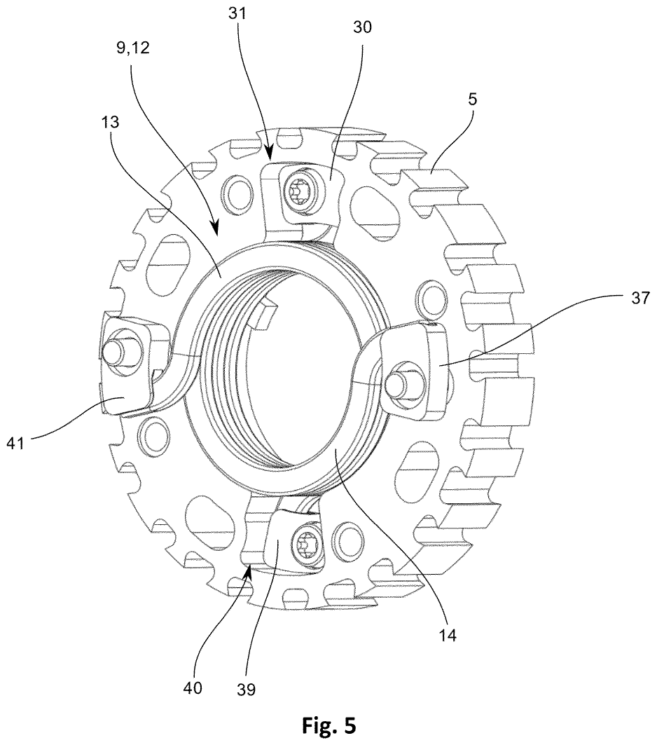

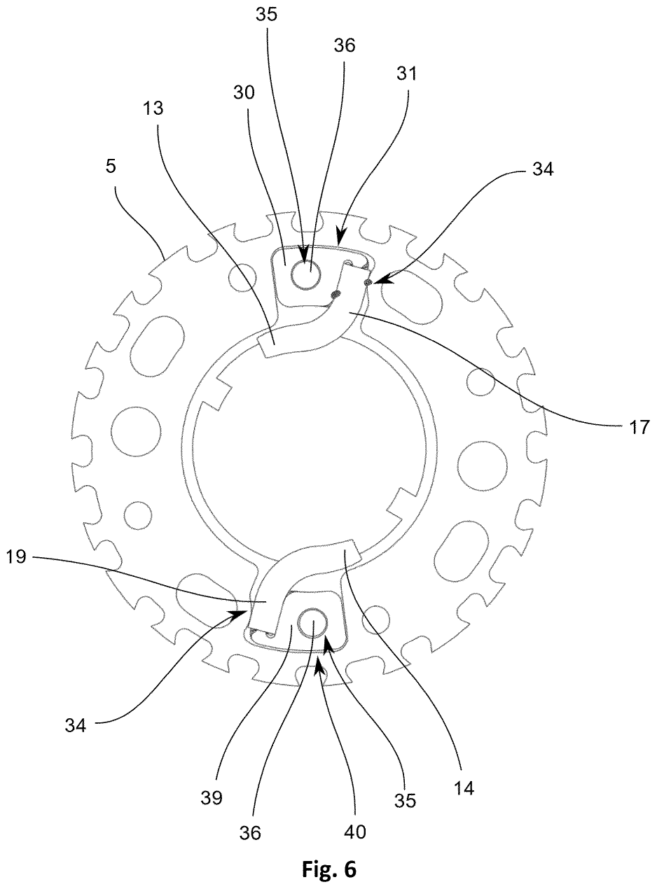

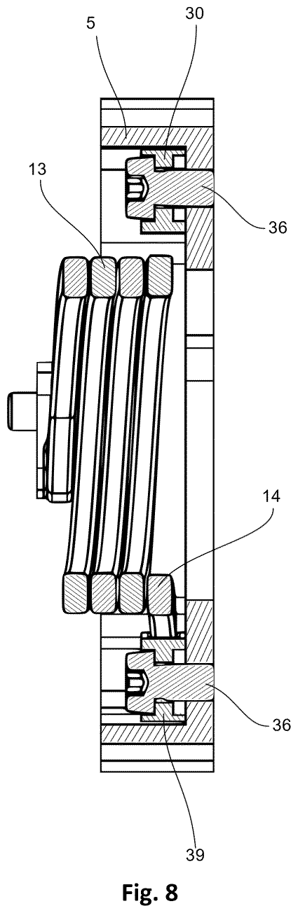

FIGS. 5-8 show various views of the leg spring arrangement 12 in a partially assembled state on the first rotor body 5.

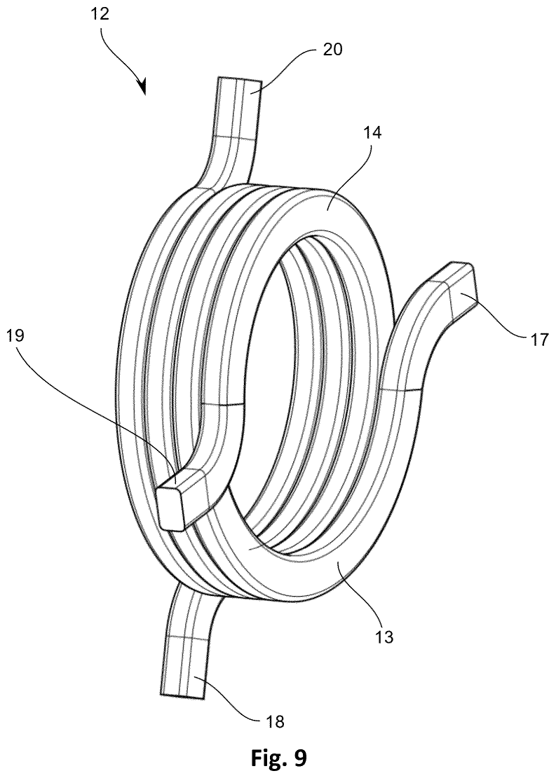

FIG. 9 shows the leg spring arrangement 12 in an exposed, perspective view. Among other things, it can be easily seen that the leg springs 13, 14 are formed from a spring wire with a substantially rectangular cross-section, wherein the short edges of the leg springs 13, 14, which are rectangular in cross-section, extend in the axial direction, while the long sides are oriented in the circumferential direction.

FIG. 3 shows three different embodiments of a receiving shoe 30. In the upper variant, designated a, the receiving groove 32 is open radially inwards and in the circumferential direction, but closed radially outwards, so that a spring leg 17 accommodated in the receiving groove 32 can also be arranged in the receiving groove 32 radially outwards in a play-free manner. In principle, it would also be conceivable to design the receiving groove 32 in the form of a channel so that a spring leg 17 can be inserted into the receiving groove 32 from radially inwards to outwards and fixed there in a play-free manner. This variant is shown in image b of FIG. 10. Furthermore, the receiving groove 32 can also be open in a radial, circumferential and axial direction, as can be seen in image c of FIG. 10.

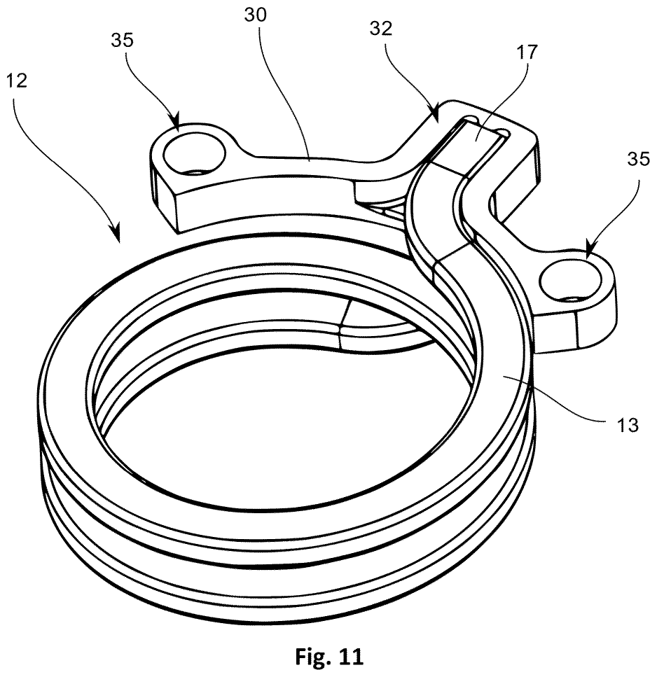

FIG. 11 shows a further embodiment of a receiving shoe 30, which is shaped like an annular segment and has an opening 35 at each of its circumferential ends for receiving a fastening means 36.

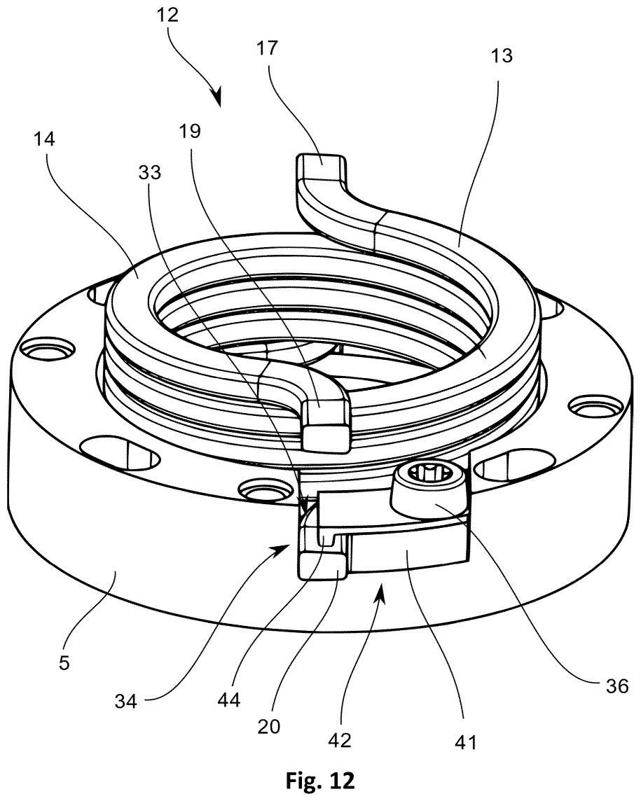

FIG. 12 shows a further embodiment of a leg spring arrangement 12 in which the spring leg 20 is axially preloaded with a spring element 44.

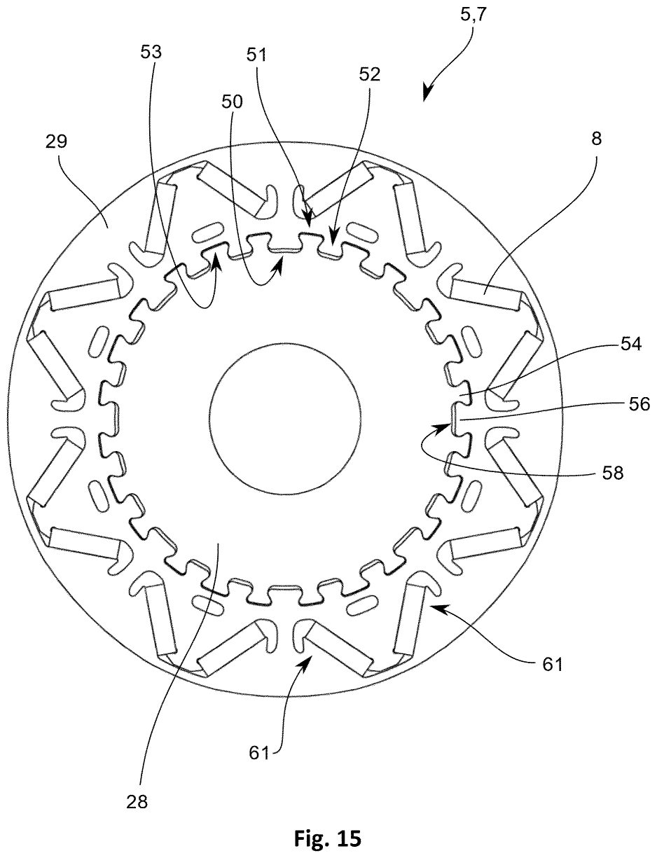

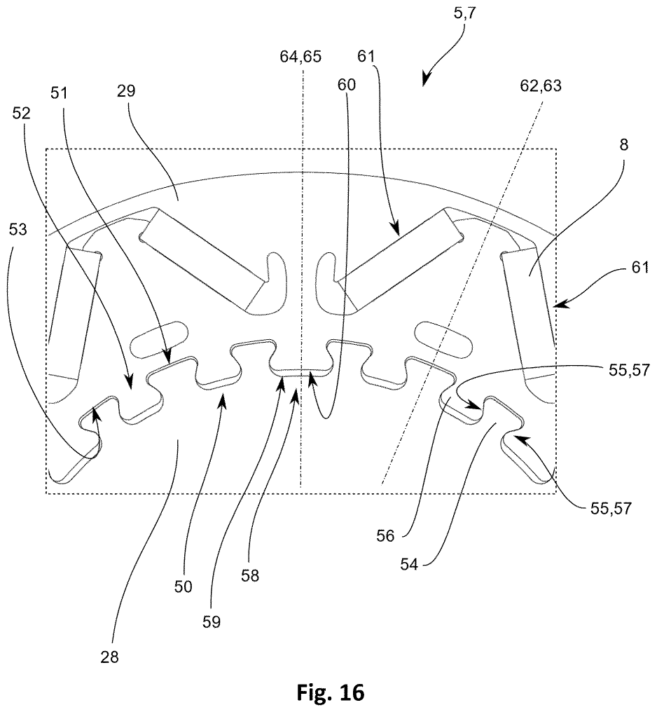

FIG. 15 and FIG. 16 show an embodiment in which the inner annular disk 28 and the outer annular disk 29 are connected to each other in a torque-transmitting manner. For this purpose, the inner annular disk 28 has an external toothing 51 on its outer circumferential surface 50, which engages in a corresponding internal toothing 52 on an inner circumferential surface 53 of the outer annular disk 29. In this exemplary embodiment, the external toothing 51 and the internal toothing 52 are designed as a plug-in toothing. In order to facilitate the joining of this plug-in toothing, the external toothing 51 and/or the internal toothing 52 can have a chamfer.

It can be seen from the detailed representation in FIG. 16 that the teeth 54 of the external toothing 51 each have a first undercut 55, and the teeth 56 of the internal toothing 52 also have a second undercut 57, wherein the first undercut 55 and the second undercut 57 are designed in such a way that a force can be transmitted in the radial direction between the meshing internal toothing 52 and external toothing 51. To achieve this, the teeth 54 of the external toothing 51 and the teeth 56 of the internal toothing 52 are dovetail-shaped in cross-section. Here, the two annular disks 28, 29 only touch on the inclined flanks of the dovetail-shaped teeth 54, 56. The high degree of accuracy of the tooth shape for a positive connection is therefore limited to the inclined flanks. This also allows larger radii to be used in the tooth base of the annular disks 28, 29. This reduces the local stresses and enables faster, more cost-effective production of the toothing 51, 52, e.g., by selecting a milling tool with a larger diameter. The undercut 55, 57 is thus created by the inclined lateral flanks of the teeth 54, 56. In this form, the openings of the tooth gaps in the annular disks 28, 29 are wider, which makes it easier and more cost-effective to produce the toothing, e.g., by broaching, shaping, or milling.

The external toothing 51 also has a groove 58 with a groove base 59 between two teeth 54 adjacent in the circumferential direction, into which a tooth 56 of the internal toothing 52 engages with a tooth tip 60, wherein the tooth tip 60 is subject to play relative to the groove base 59, which can be easily understood from the gap shown in FIG. 4. In this design, an overlap can be specifically provided in the tooth flanks of the meshing teeth 54, 56, which leads to an inward preload of the inner annular disk 28 with the outer annular disk 29 during assembly and thus further reduces the stresses in the annular disks 28, 29 under speed.

The permanent magnets 6, 8 are arranged in cross-section in pairs in a V-shape distributed over the circumference of an outer annular disk 29, wherein the free legs 61 of the V-shaped arrangement extend radially inwards, and the V-shaped arrangement has a radially extending mirror axis 62, which extends coaxially to a radially extending mirror axis 63 of a tooth 54, 56 of the internal toothing 52 or external toothing 51. At the same time, a radially extending mirror axis 64 is defined between two adjacent V-shaped arrangements in the circumferential direction, which extends coaxially to a radially extending mirror axis 65 of a tooth 56 of the internal toothing 52 or external toothing 51. In this context, FIG. 4 also clearly shows that the teeth 54, 56 in engagement, through which the mirror axes 62, 63 extend, are wider in the circumferential direction than the adjacent teeth 54, 56 in the circumferential direction. The same applies to the meshing teeth 54, 56, through which the mirror axes 64, 65 run.

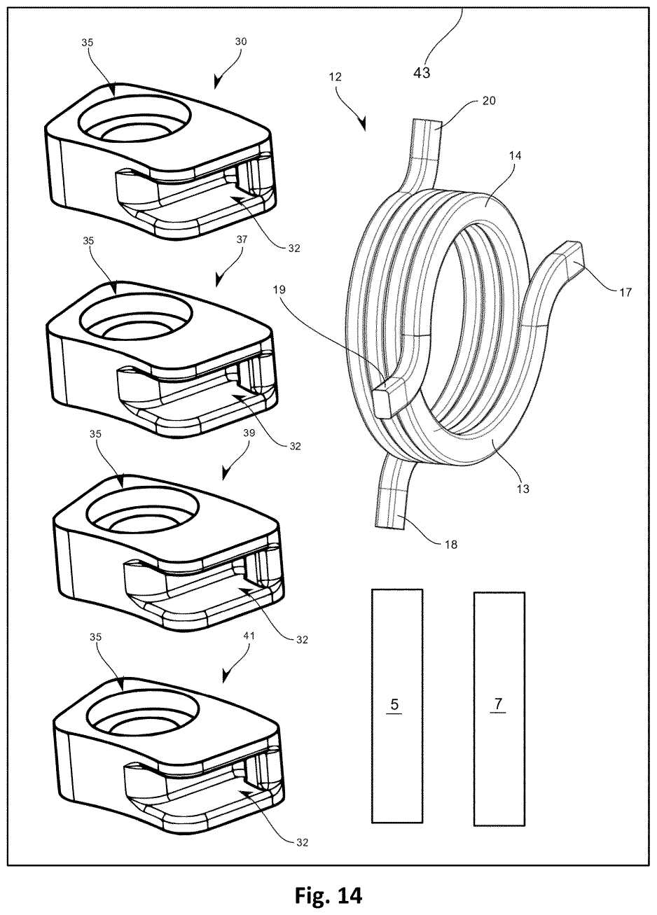

FIG. 14 shows a kit-of-parts 43 for producing a mechanical field-attenuating mechanism 11 for a rotor 4 of an electric machine 1, in particular for use within the powertrain of a hybrid or fully electrically driven motor vehicle, including
a first rotor body 5, having a first receiving pocket 31, and a second rotor body 7, wherein the first rotor body 5 and the second rotor body 7 can be rotated relative to each other about a common rotational axis 10 against the effect of a first torsional stiffness 9,
a first torsional stiffness 9, which is designed as a first leg spring arrangement 12 having a first leg spring 13, which can be positioned coaxially to the rotational axis 10 and between the first rotor body 5 and the second rotor body 7 or between one of the rotor bodies 5, 7 and a rotor shaft 16 in such a way that the rotation of one of the rotor bodies 5, 7, which begins when the field-attenuating mechanism 11 is adjusted, can cause the first leg spring 13 to open or close, and the first leg spring 13 has at least one first spring leg 17, and
a first receiving shoe 30, in which the first spring leg 17 can be positioned and the receiving shoe 30 in turn can be received in the first receiving pocket 31 of the first rotor body 5 and can be fixed to the first rotor body 5 in such a way that the first spring leg 17 of the first leg spring 13 can be coupled to the first rotor body 5 in a play-free manner in the axial as well as in the circumferential direction relative to the first rotor body.

As shown, the kit-of-parts 43 can provide a receiving shoe 30, 37, 39, 41 for all spring legs 17, 18, 19, 20 of the leg spring arrangement 12, wherein the receiving shoes 30, 37, 39, 41 are designed substantially identically.

The present disclosure is not limited to the embodiments shown in the figures. The above description is therefore not to be regarded as limiting, but rather as illustrative. The following claims are to be understood as meaning that a stated feature is present in at least one embodiment of the present disclosure. This does not exclude the presence of further features. Where the claims and the above description define “first” and “second” features, this designation serves to distinguish between two features of the same type without defining an order of precedence.

### LIST OF REFERENCE SYMBOLS

1 Electric machine
2 Stator
3 Air gap
4 Rotor
5 Rotor body
6 Permanent magnets
7 Rotor body
8 Permanent magnets
9 Torsional stiffness
10 Rotational axis
11 Field-attenuating mechanism
12 Leg spring arrangement
13 Leg spring
14 Leg spring
16 Rotor shaft
17 Spring leg
18 Spring leg
19 Spring leg
20 Spring leg
28 Annular disk
29 Annular disk
30 Receiving shoe
31 Receiving pocket
32 Receiving groove
33 Section
34 Wall
35 Opening
36 Fastening means
37 Receiving shoe
38 Receiving pocket
39 Receiving shoe
40 Receiving pocket
41 Receiving shoe
42 Receiving pocket
43 Kit-of-parts
44 Spring element
50 Lateral surface
51 External toothing
52 Internal toothing
53 Lateral surface
54 Teeth
55 Undercut
56 Teeth
57 Undercut
58 Groove
59 Groove base
60 Tooth tip
61 Leg
62 Mirror axis
63 Mirror axis
64 Mirror axis
65 Mirror axis

1. An electric machine, for use within a powertrain of a hybrid or fully electrically driven motor vehicle, comprising:
a stator; and
a rotor which is separated from the stator by an air gap,
wherein the rotor has at least one first rotor body with a first group of permanent magnets and a second rotor body with a second group of permanent magnets,
wherein the first rotor body and the second rotor body are rotatable relative to each other about a common rotational axis against an effect of a first torsional stiffness by a mechanical field-attenuating mechanism,
wherein the first torsional stiffness is configured as a first leg spring arrangement having a first leg spring which is arranged coaxially to the rotational axis and between the first rotor body and the second rotor body or between one of the rotor bodies and a rotor shaft in such a way that rotation of one of the rotor bodies, which begins when the field-attenuating mechanism is adjusted, causes the first leg spring to open or close, and
wherein a first spring leg of the first leg spring is held in a first receiving shoe, which in turn is received in a first receiving pocket of the first rotor body and is fixed to the first rotor body in such a way that the first spring leg of the first leg spring is coupled to the first rotor body in a play-free manner in an axial direction as well as in a circumferential direction relative to the first rotor body.

2. The electric machine according to claim 1, wherein the first receiving shoe can be inserted into the first receiving pocket with play.

3. The electric machine according to claim 1, wherein the first receiving shoe has a first receiving groove in which the first spring leg of the first leg spring is arranged in a play-free manner.

4. The electric machine according to claim 3, wherein the first spring leg of the first leg spring projects from the first receiving groove, wherein a section projecting from the first receiving groove rests against a wall of the first receiving pocket.

5. The electric machine according to claim 4, wherein the wall of the first receiving pocket has a convex contour projecting into the first receiving pocket.

6. The electric machine according to claim 1, wherein the first receiving shoe has a first opening which is penetrated by a first fastening means by which the first receiving shoe is fixed to the first rotor body.

7. The electric machine according to claim 1, wherein
the first leg spring arrangement has a second leg spring which is arranged coaxially to the rotational axis of the rotor and between the first rotor body and the second rotor body or between one of the rotor bodies and the rotor shaft, and
the rotation of one of the rotor bodies, which begins when the field-attenuating mechanism is adjusted, causes the second leg spring to open or close, and the first leg spring and the second leg spring are configured as substantially identical parts and are arranged rotated relative to each other about the rotational axis so that the first spring leg and a second spring leg of the first leg spring point in at least one of a common radial direction or axial direction and a first spring leg and a second spring leg of the second leg spring are oriented in at least one of a radial direction or axial direction opposite thereto.

8. The electric machine according to claim 7, wherein at least one of
the second spring leg of the first leg spring is held in a second receiving shoe which in turn is received in a second receiving pocket of the second rotor body and is fixed to the first rotor body in such a way that the second spring leg of the first leg spring is coupled to the second rotor body in a play-free manner in an axial direction as well as in a circumferential direction relative to the second rotor body,
the first spring leg of the second leg spring is held in a third receiving shoe, which in turn is received in a third receiving pocket of the first rotor body and is fixed to the first rotor body in such a way that the first spring leg of the second leg spring is coupled to the first rotor body in a play-free manner in the axial direction as well as in the circumferential direction relative to the first rotor body, or
the second spring leg of the second leg spring is held in a fourth receiving shoe which in turn is received in a fourth receiving pocket of the second rotor body and is fixed to the second rotor body in such a way that the second spring leg of the second leg spring is coupled to the second rotor body in a play-free manner in the axial direction as well as in the circumferential direction relative to the second rotor body.

9. The electric machine according to claim 8, wherein the first receiving shoe, the second receiving shoe, the third receiving shoe and the fourth receiving shoe are identical.

10. A method for producing a mechanical field-attenuating mechanism, comprising:
providing a first rotor body having a first receiving pocket and a second rotor body,
providing a first torsional stiffness, which is configured as a first leg spring arrangement having a first leg spring, which has a first spring leg and a second spring leg,
providing a first receiving shoe,
fixing the first receiving shoe to the first spring leg in a play-free manner,
inserting the first receiving shoe into the first receiving pocket with play,
fixing the receiving shoe to the first rotor body, so that the first spring leg of the first leg spring is coupled to the first rotor body in a play-free manner in an axial direction as well as in a circumferential direction relative to the first rotor body,
coupling the second spring leg to the second rotor body or a rotor shaft,
wherein the first rotor body and the second rotor body are rotated relative to each other about a common rotational axis against an effect of the first torsional stiffness, so that a rotation of one of the rotor bodies which begins when the field-attenuating mechanism is adjusted, causes the first leg spring to open or close.

11. A mechanical field-attenuating mechanism for a rotor of an electric machine, wherein the rotor has at least one first rotor body and a second rotor body, wherein the first rotor body and the second rotor body are rotatable relative to each other about a common rotational axis against an effect of a first torsional stiffness,
wherein the first torsional stiffness is designed as a first leg spring arrangement having a first leg spring, which is arranged coaxially to the rotational axis and between the first rotor body and the second rotor body or between one of the rotor bodies and a rotor shaft in such a way that rotation of one of the rotor bodies, which begins when the field-attenuating mechanism is adjusted, causes the first leg spring to open or close, and
wherein a first spring leg of the first leg spring is held in a first receiving shoe, which in turn is received in a first receiving pocket of the first rotor body and is fixed to the first rotor body in such a way that the first spring leg of the first leg spring is coupled to the first rotor body in a play-free manner in an axial direction as well as in a circumferential direction relative to the first rotor body.

12. A kit of parts for producing a mechanical field-attenuating mechanism for a rotor of an electric machine, the kit comprising:
a first rotor body, having a first receiving pocket, and a second rotor body, wherein the first rotor body and the second rotor body can be rotated relative to each other about a common rotational axis against an effect of a first torsional stiffness,
a first torsional stiffness, which is configured as a first leg spring arrangement having a first leg spring which is positioned coaxially to the rotational axis and between the first rotor body and the second rotor body or between one of the rotor bodies and a rotor shaft in such a way that rotation of one of the rotor bodies which begins when the field-attenuating mechanism is adjusted, causes the first leg spring to open or close, and the first leg spring has a first spring leg, and
a first receiving shoe in which the first spring leg is positioned and the receiving shoe in turn is received in the first receiving pocket of the first rotor body and is fixed to the first rotor body in such a way that the first spring leg of the first leg spring is coupled to the first rotor body in a play-free manner in an axial direction as well as in a circumferential direction relative to the first rotor body.

13. The mechanical field-attenuating mechanism according to claim 11, wherein the electric machine is configured for use within a powertrain of a hybrid or fully electrically driven motor vehicle.

14. The kit of parts according to claim 12, wherein the electric machine is an electric machine for a powertrain of a hybrid or fully electrically driven motor vehicle.
